(19) United States
(12) Patent Application Publication
(10) Pub. No.: US 2002/0174428 A1
(43) Pub. Date: Nov. 21, 2002

(54) Method and apparatus for generating recommendations for a plurality of users

(75) Inventors: Lalitha Agnihotri, Fishkill, NY (US); Srinivas Gutta, Buchanan, NY (US)

Correspondence Address: Corporate Patent Counsel, U.S. Philips Corporation, 580 White Plains Road, Tarrytown, NY, 10591, US

(73) Assignee: Philips Electronics North America Corp.

(21) Appl. No.: 09/819,440

(22) Filed: Mar. 28, 2001

(51) Int. Cl. H04N 5/445; H04N 7/16

(52) U.S. Cl. 725/46; 725/9

(57) ABSTRACT

A recommendation system is disclosed that generates recommendations for one or more items based on the combined preferences of a number of individuals. The disclosed recommender initially identifies the individuals that are present, and thereafter generates a recommendation score based on the combined preferences of each user. In one implementation, a recommendation score is first computed for each individual, before a combined recommendation score is computed for the entire group. The combined recommendation score, C, can be computed, for example, using an average or a weighted average.

### FIELD OF THE INVENTION

The present invention relates to recommendation systems, such as recommenders for television programming or other content, and more particularly, to a method and apparatus for generating recommendations for a number of users.

### BACKGROUND OF THE INVENTION

The number of media options available to individuals is increasing at an exponential pace. As the number of channels available to television viewers has increased, for example, along with the diversity of the programming content available on such channels, it has become increasingly challenging for television viewers to identify television programs of interest. Historically, television viewers identified television programs of interest by analyzing printed television program guides. Typically, such printed television program guides contained grids listing the available television programs by time and date, channel and title. As the number of television programs has increased, it has become increasingly difficult to effectively identify desirable television programs using such printed guides.

More recently, television program guides have become available in an electronic format, often referred to as electronic program guides (EPGs). Like printed television program guides, EPGs contain grids listing the available television programs by time and date, channel and title. Some EPGs, however, allow television viewers to sort or search the available television programs in accordance with personalized preferences. In addition, EPGs allow for on-screen presentation of the available television programs.

Many viewers have a particular preference towards, or bias against, certain categories of programming, such as action-based programs or sports programming. A number of tools are available that recommend television programs by applying such viewer preferences to the EPG to obtain a set of recommended programs. While currently available television program recommenders identify programs that are likely of interest to a given viewer, they are unable to identify programs that are likely of interest to a group of viewers. Thus, a television program recommender cannot be effectively employed when there is more than one person present, unless the generated recommendations are based on the preferences of only a single user, which may have no bearing on the preferences of the others that are present.

A need therefore exists for a method and apparatus for generating recommendations for a group of users. A further need exists for a method and apparatus for deriving the preferences for an entire group of individuals. Yet another need exists for a method and apparatus for integrating individual item recommendations in order to recommend an item that is likely of interest to an entire group.

### SUMMARY OF THE INVENTION

Generally, a recommendation system is disclosed that generates recommendations for one or more items based on the combined preferences of a number of individuals. Thus, the disclosed recommender initially identifies the individuals that are present, and thereafter generates a recommendation score based on the combined preferences of each user. In one implementation, a recommendation score is first computed for each individual, before a combined recommendation score is computed for the entire group. The combined recommendation score, C, can be computed, for example, using an average or a weighted average. A more complete understanding of the present invention, as well as further features and advantages of the present invention, will be obtained by reference to the following detailed description and drawings.

### BRIEF DESCRIPTION OF THE DRAWINGS

FIG. 1 illustrates a television programming recommender in accordance with the present invention;

FIG. 2 illustrates a sample table from the program database of FIG. 1;

FIG. 3A illustrates a sample table from a Bayesian implementation of the viewer profile of FIG. 1;

FIG. 3B illustrates a sample table from a viewing history used by a decision tree (DT) recommender;

FIG. 3C illustrates a sample table from a viewer profile generated by a decision tree (DT) recommender from the viewing history of FIG. 3B; and

FIG. 4 is a flow chart describing an exemplary multi-viewer program recommendation process embodying principles of the present invention.

### DETAILED DESCRIPTION

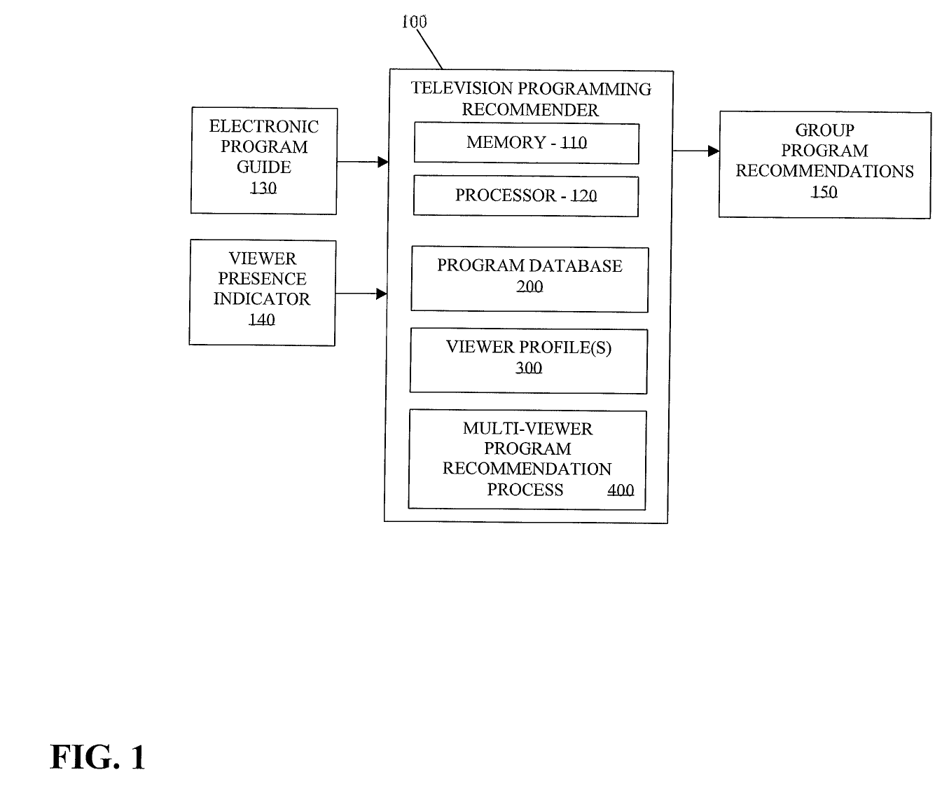

FIG. 1 illustrates a television programming recommender 100 in accordance with the present invention. As shown in FIG. 1, the television programming recommender 100 evaluates each of the programs in an electronic programming guide (EPG) 130 to identify programs of interest to a number of viewers. The set of recommended programs can be presented to the viewers using a set-top terminal/television (not shown), for example, using well known on-screen presentation techniques. While the present invention is illustrated herein in the context of television programming recommendations, the present invention can be applied to any automatically generated recommendations that are based on an evaluation of user behavior, such as a viewing history or a purchase history. The present invention is particularly applicable in a closed environment, such as an automobile or a home, where a number of related individuals often experience a selected recommended item together, such as a recommended program on television.

The television programming recommender 100 generates recommendations for a group of viewers, based on the preferences of the viewers that are present. Generally, a viewer presence indicator 140 identifies the individuals that are present at a given time. Any active or passive technique can be employed to determine the identity of individuals that are present, such as requiring the users that are present to press an associated button on a console or remote control, or a biometric evaluation technique, such as speech or face recognition, fingerprint analysis or an iris scan.

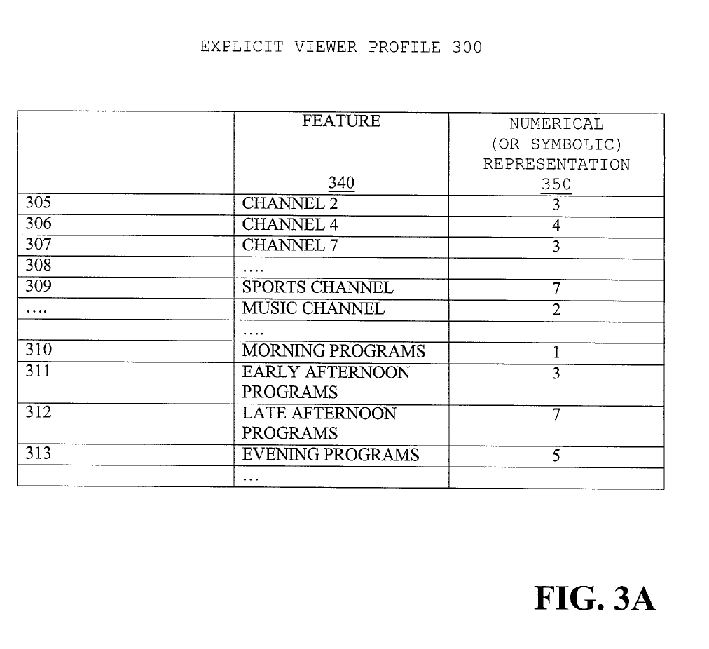

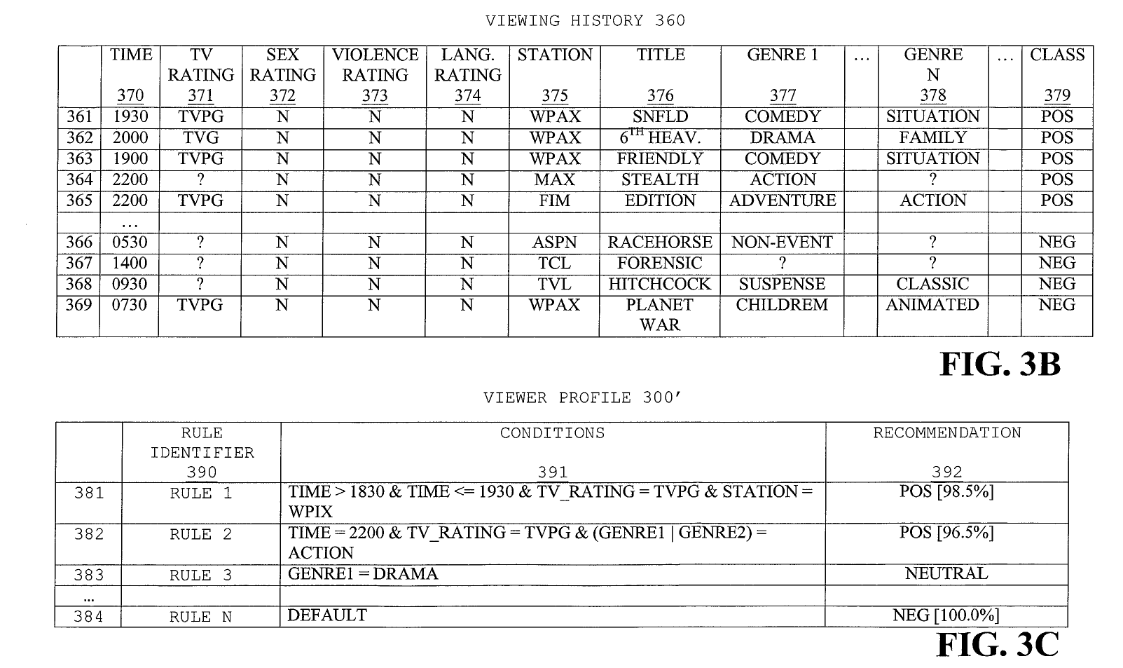

Once each of the individuals that are present are identified, the television programming recommender 100 can generate a set of group program recommendations 150 identifying programs that are likely to be of interest to the entire group. In one exemplary implementation, the television programming recommender 100 integrates the individual program recommendations of each viewer, for example, using straight or weighted averages, to generate the group program recommendations 150. The group program recommendations 150 identify programs that are most likely to be of interest to those individuals that are present. In an alternate implementation, the television programming recommender 100 maintains a viewing history (positive and negative examples of programs watched and not watched, respectively) for each individual and then generates a group profile from the viewing histories of those individuals that are present at a given time, in a manner described further below in conjunction with FIG. 3C.

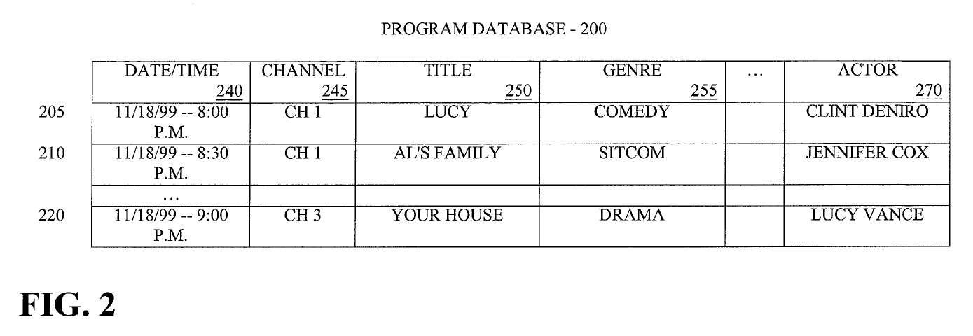

As shown in FIG. 1 the television programming recommender 100 contains a program database 200, one or more viewer profiles 300, and a multi-viewer program recommendation process 400, each discussed further below in conjunction with FIGS. 2 through 4, respectively. Generally, the program database 200 records information for each program that is available in a given time interval. One illustrative viewer profile 300, shown in FIG. 3A, is an explicit viewer profile that is typically generated from a viewer survey that provides a rating for each program feature, for example, on a numerical scale that is mapped to various levels of interest between “hates” and “loves, ” indicating whether or not a given viewer watched each program feature. Another exemplary viewer profile 300′, shown in FIG. 3C, is generated by a decision tree recommender, based on an exemplary viewing history 360, shown in FIG. 3B. The multi-viewer program recommendation process 400 generates the group program recommendations 150 based on the preferences of the viewers that are present.

The television program recommender 100 may be embodied as any computing device, such as a personal computer or workstation, that contains a processor 120, such as a central processing unit (CPU), and memory 110, such as RAM and/or ROM. In addition, the television programming recommender 100 may be embodied as any available television program recommender, such as the Tivo™ system, commercially available from Tivo, Inc., of Sunnyvale, Calif., or the television program recommenders described in U.S. patent application Ser. No. 09/466,406, filed Dec. 17, 1999, entitled “Method and Apparatus for Recommending Television Programming Using Decision Trees,” (Attorney Docket No. 700772), U.S. patent application Ser. No. 09/498,271, filed Feb. 4, 2000, entitled “Bayesian TV Show Recommender,” (Attorney Docket No. 700690) and U.S. patent application Ser. No. 09/627,139, filed Jul. 27, 2000, entitled “Three-Way Media Recommendation Method and System,”(Attorney Docket No. 700913), or any combination thereof, as modified herein to carry out the features and functions of the present invention. In a further variation, the television program recommender 100 may be embodied as an application specific integrated circuit (ASIC) that may be incorporated, for example, in a set-top terminal or television.

FIG. 2 is a sample table from the program database 200 of FIG. 1 that records information for each program that is available in a given time interval. As shown in FIG. 2, the program database 200 contains a plurality of records, such as records 205 through 220, each associated with a given program. For each program, the program database 200 indicates the date/time and channel associated with the program in fields 240 and 245, respectively. In addition, the title, genre and actors for each program are identified in fields 250, 255 and 270, respectively. Additional well-known features (not shown), such as duration and description of the program, can also be included in the program database 200.

FIG. 3A is a table illustrating an exemplary explicit viewer profile 300 that may be utilized by a Bayesian television recommender. As shown in FIG. 3A, the explicit viewer profile 300 contains a plurality of records 305-313 each associated with a different program feature. In addition, for each feature set forth in column 340, the viewer profile 300 provides a numerical representation in column 350, indicating the relative level of interest of the viewer in the corresponding feature. As discussed below, in the illustrative explicit viewer profile 300 set forth in FIG. 3A, a numerical scale between 1 (“hate”) and 7 (“love”) is utilized. For example, the explicit viewer profile 300 set forth in FIG. 3A has numerical representations indicating that the user particularly enjoys programming on the Sports channel, as well as late afternoon programming.

In an exemplary embodiment, the numerical represention in the explicit viewer profile 300 includes an intensity scale such as

| Number | Description |
|---|---|
| 1 | Hates |
| 2 | Dislikes |
| 3 | Moderately negative |
| 4 | Neutral |
| 5 | Moderately positive |
| 6 | Likes |
| 7 | Loves |

FIG 3B is a table illustrating an exemplary viewing history 360 that is maintained by a decision tree television recommender. As shown in FIG. 3B, the viewing history 360 contains a plurality of records 361-369 each associated with a different program. In addition, for each program, the viewing history 360 identify various program features in fields 370-379. The values set forth in fields 370-379 may be typically obtained from the electronic program guide 130. It is noted that if the electronic program guide 130 does not specify a given feature for a given program, the value is specified in the viewing history 360 using a “?”.

FIG. 3C is a table illustrating an exemplary viewer profile 300′ that may be generated by a decision tree television recommender from the viewing history 360 set forth in FIG. 3B. As shown in FIG. 3C, the decision tree viewer profile 300′ contains a plurality of records 381-384 each associated with a different rule specifying viewer preferences. In addition, for each rule identified in column 390, the viewer profile 300′ identifies the condition associated with the rule in field 391 and the corresponding recommendation in field 392.

For a more detailed discussion of the generation of viewer profiles in a decision tree recommendation system, see, for example , U.S. patent application Ser. No. 09/466,406 filed dec. 17, 1999, entitled “Method and Apparatus for Recommending Television Programming Using Decision Trees,” incorporated by reference above.

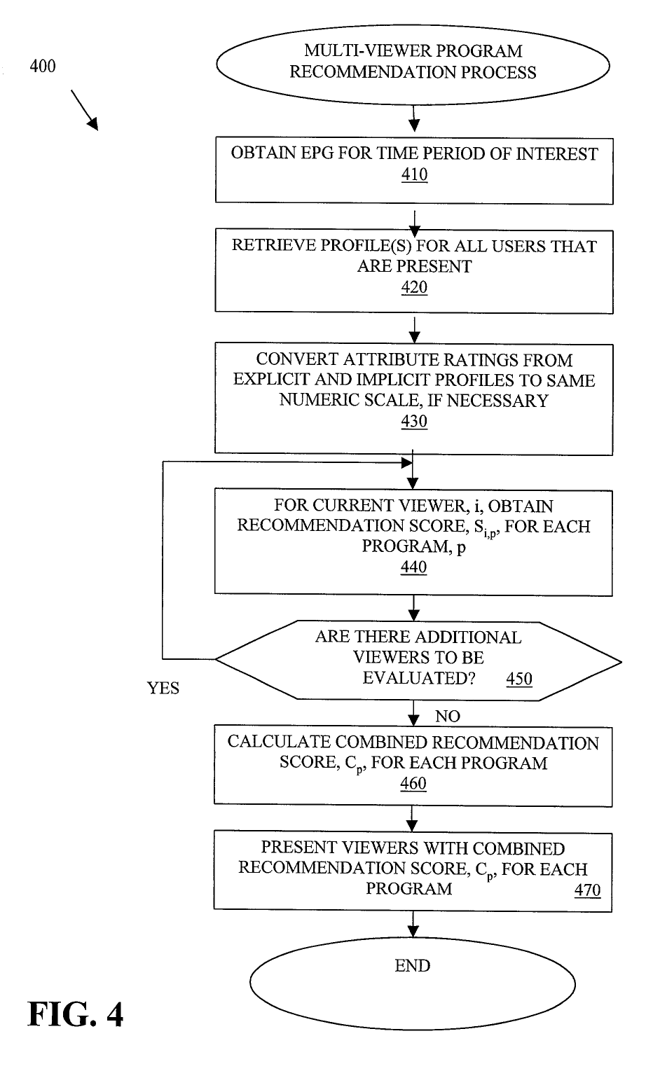

FIG. 4 is a flow chart describing an exemplary multi-viewer program recommendation process 400. The multi-viewer program recommendation process 400 generates the group program recommendations 150 based on the preferences of the viewers that are present. As shown in FIG. 4, the multi-viewer program recommendation process 400 initially obtains the electronic program guide (EPG) 130 during step 410 for the time period of interest. Thereafter, the appropriate viewer profiles 300 are obtained for the viewers that are present during step 420. The multi-viewer program recommendation process 400 then converts the numeric ratings for each attribute from the viewer profiles 300, 300′ to the same numeric scale, if necessary, during step 430.

The recommendation score, S_{i,p}, is obtained during step 440 for the current viewer, i, for each program, p. For example, the recommendation score, S_{i,p}, may be calculated by a decision tree recommendation system in accordance with the techniques described in U.S. patent application Ser. No. 09/466,406, filed Dec. 17, 1999, entitled “Method and Apparatus for Recommending Television Programming Using Decision Trees,” incorporated by reference above. For a discussion of the calculation of the recommendation score, S_{i,p}, by a Bayesian recommendation system, see, for example, United States Patent Application, filed Feb. 4, 2000, entitled “Bayesian Television Show Recommender,” (Attorney Docket Number US000018), incorporated by reference herein.

A test is performed during step 450 to determine if there are additional viewers to be evaluated. If it is determined during step 450 that there are additional viewers to be evaluated, then program control returns to step 440 and continues processing in the manner described above. If, however, it is determined during step 450 that there are no additional viewers present to be evaluated, then program control proceeds to step 460.

During step 460, a combined recommendation score, Cₚ, is calculated for each program, based on the viewing preferences of all those viewers that are present. For example, the combined recommendation score, Cₚ, may be calculated using a weighted average as follows:

Cₚ=Σᵢ₌₁^{n w}^{ᵢ}^{s}^{ᵢ}/N·Σᵢ₌₁ ^{N}Wᵢ

where N is the number of viewers present, wᵢ is the weight of a user, i, and Sᵢ, is the recommendation score computed during step 440. In a further variation, the combined recommendation score, Cₚ, may be calculated using a straight average as follows:

Cₚ=Σᵢ₌₁^{N S}^{ᵢ}/N·.

In yet another variation, a combined recommendation score, Cₚ, will be computed for a given program only if the recommendation score, S_{i,p}, exceeds a predefined threshold for each user that is present. In this manner, if a given program scores very poorly for one user, the program will not appear in the group recommendations 150.

Finally, the viewers are presented with the calculated combined recommendation score, Cₚ, for each program (or for the top-N programs) during step 770, before program control terminates.

It is to be understood that the embodiments and variations shown and described herein are merely illustrative of the principles of this invention and that various modifications may be implemented by those skilled in the art without departing from the scope and spirit of the invention.

What is claimed is:

1. A method for recommending an item to a group of users, comprising the steps of:
identifying said group of users; and
generating a recommendation score for said item based on features of said item and preferences of each of said users.

2. The method of claim 1, wherein said item is a program.

3. The method of claim 1, wherein said item is content.

4. The method of claim 1, wherein said item is a product.

5. The method of claim 1, wherein said recommendation score is computed as a weighted average of individual recommendation scores indicating a degree to which said item is likely to be of interest to each of said users.

6. The method of claim 1, wherein said recommendation score is computed using a straight average of individual recommendation scores indicating a degree to which said item is likely to be of interest to each of said users.

7. The method of claim 1, wherein said recommendation score is computed by analyzing a profile for said group of users indicating individual preferences of each of said users.

8. A method for recommending an item to a group of users, comprising the steps of:
identifying said group of users;
generating an individual recommendation score for said item for each of said users, said individual recommendation scores based on features of said item and preferences of said corresponding user; and
generating a combined recommendation score for said item based on said individual recommendation scores.

9. The method of claim 8, wherein said item is a program.

10. The method of claim 8, wherein said item is content.

11. The method of claim 8, wherein said item is a product.

12. The method of claim 8, wherein said combined recommendation score is computed as a weighted average of said individual recommendation scores.

13. The method of claim 8, wherein said combined recommendation score is computed using a straight average of said individual recommendation scores.

14. A system for recommending an item to a group of users, comprising:
a memory for storing computer readable code; and
a processor operatively coupled to said memory, said processor configured to:
identify said group of users; and
generate a recommendation score for said item based on features of said item and preferences of each of said users.

15. The system of claim 14, wherein said recommendation score is computed as a weighted average of individual recommendation scores indicating a degree to which said item is likely to be of interest to each of said users.

16. The system of claim 14, wherein said recommendation score is computed using a straight average of individual recommendation scores indicating a degree to which said item is likely to be of interest to each of said users.

17. The system of claim 14, wherein said recommendation score is computed by analyzing a profile for said group of users indicating individual preferences of each of said users.

18. A system for recommending an item to a group of users, comprising:
a memory for storing computer readable code; and
a processor operatively coupled to said memory, said processor configured to:
identify said group of users;
generate an individual recommendation score for said item for each of said users, said individual recommendation scores based on features of said item and preferences of said corresponding user; and
generate a combined recommendation score for said item based on said individual recommendation scores.

19. The system of claim 18, wherein said combined recommendation score is computed as a weighted average of said individual recommendation scores.

20. The system of claim 18, wherein said combined recommendation score is computed using a straight average of said individual recommendation scores.

21. An article of manufacture for recommending an item to a group of users, comprising:
a computer readable medium having computer readable code means embodied thereon, said computer readable program code means comprising:
a step to identify said group of users; and
a step to generate a recommendation score for said item based on features of said item and preferences of each of said users.

22. An article of manufacture for recommending an item to a group of users, comprising:
a computer readable medium having computer readable code means embodied thereon, said computer readable program code means comprising:
a step to identify said group of users;
a step to generate an individual recommendation score for said item for each of said users, said individual recommendation scores based on features of said item and preferences of said corresponding user; and
a step to generate a combined recommendation score for said item based on said individual recommendation scores.
